(19) United States
(12) Patent Application Publication
(10) Pub. No.: US 2004/0210380 A1
(43) Pub. Date: Oct. 21, 2004

(54) Traveling machine management system

(76) Inventors: Tadashi Morita, Hiratsuka City (JP); Takao Nagai, Yokohama City (JP)

Correspondence Address: VARNDELL & VARNDELL, PLLC, 106-A S. COLUMBUS ST., ALEXANDRIA, VA, 22314, US

(21) Appl. No.: 10/757,462

(22) Filed: Jan. 15, 2004

(30) Foreign Application Priority Data
Jan. 16, 2003 (JP) 2003-008592

(51) Int. Cl. G01C 21/28

(52) U.S. Cl. 701/200; 701/210

(57) ABSTRACT

There is provided a traveling machine management system in which terminals used on different traveling machines can be managed on a server. In a traveling machine management system having terminals provided on traveling machines and a server through a communication channel connected to the terminals for managing the traveling machines, unique and fixed identifiers are given to the terminals, and the server has unit for acquiring the identifiers of the terminals and a unit for managing the communication period of the terminals based on the acquired identifiers. The use of the identifiers unique to the terminals allows management to be carried out independently of the traveling machines even when the terminals are used on different traveling machines.

### BACKGROUND OF THE INVENTION

1. Field of the Invention

The present invention relates to a traveling machine management system having a terminal provided on a traveling machine and a server connected to the terminal through a communication channel.

2. Description of Related Art

As a result of recent advances of GPS (Global Positioning Systems), systems have been proposed in which travels and operating sites of traveling machines such as construction machines are managed by loading terminals on the traveling machines and outputting information on the positions of the traveling machines acquired by the terminals through a communication channel to a server that manages the traveling machines as a whole or servers installed at the sites (for example, see Patent Document 1).

In a system of this type, since the object of management is traveling machines, information identifying the traveling machines such as the serial numbers of the traveling machines has been used as identifiers. Therefore, a charge for the use of a communication channel has been billed by employing a method in which the charge is calculated by obtaining total time of use at each traveling machine using information identifying the traveling machine as an identifier and the owner of the traveling machine is billed by the communication company who owns the communication channel.

Patent Document 1: JP-A-2002-91547 (FIG. 1)

However, the management utilizing such identifiers identifying traveling machines has a problem in that operations of traveling machines cannot be properly managed and charges for the use of a communication channel cannot be properly billed unless the terminals and the traveling machines are treated integrally and inseparably.

Specifically, when a terminal which has been loaded on a certain traveling machine is loaded on another traveling machine, it is obvious that information different from operational information accumulated until that time will be output through the communication channel from the latter machine, which disallows proper management of the operation of the traveling machine.

When the possibility of separating a traveling machine and a terminal is taken into consideration, a charge for the use of a communication channel must be billed as a charge after adding the time of use each time the machine has been used, which results in a problem in that the calculation of the charge is troublesome.

Meanwhile, for example, an owner of a plurality of traveling machine may wish to manage the traveling machines by installing a single terminal on the different traveling machines depending on purposes of use.

When a traveling machine is resold or transferred, the reseller may think of using the terminal which has been loaded on the traveling machine on another traveling machine.

It is an object of the invention to provide a traveling machine management system in which a terminal can be managed on a server even when it is used on different traveling machines.

### SUMMARY OF THE INVENTION

The invention achieves the above object by applying a unique and fixed identifier to a terminal loaded on a traveling machine and managing the traveling machine at a server based on the identifier.

(1) Specifically, there is provided a traveling machine management system comprising a terminal provided on a traveling machine and a server connected to the terminal through a communication channel for managing the traveling machine, characterized in that a unique and fixed identifier is given to the terminal and in that the server has means which acquires the identifier of the terminal and means which manages a communication period of the terminal based on the acquired identifier.

The communication channel is preferably a radio communication channel from the viewpoint of the management of the traveling machine, and a dedicated radio channel utilizing a communication satellite provided by a communication company or a public radio channel such as a portable telephone or PHS (personal handy phone) may be used, for example.

The terminal may be configured as a computer having a processing unit and a storage unit, and it acquires states of operation of the traveling machine with a sensor, acquires information on the current position of the traveling machine using a GPS or the like, records such information in the storage unit, and outputs it to the server on a wireless basis as occasions demand.

Further, the server connected to the terminal through a communication channel may be a server that is installed in the site of the operation of the traveling machine, and it is preferably a server such as an ASP (application service provider) which can collect information of traveling machines on a centralized basis and which can be connected to a system possessed by the user of each terminal through a communication channel to distribute the information to each of the systems.

According to the invention, a unique and fixed identifier is given to a terminal and a traveling machine is managed at a server based on the identifier to allow management of the traveling machine on the basis of the terminal. Therefore, the management can be carried out independent of transfers of traveling machines without relying upon the traveling machines on which the terminals are loaded. When a terminal is moved from one traveling machine to another, the traveling machines can be easily managed by building a database showing correspondence between terminal identifiers and identification information of traveling machines such as serial numbers thereof at the server.

By managing the communication period of a terminal based on the identifier of the terminal, the terminal can be traded with a predetermined communication period available for the terminal. This allows a prepayment or lump sum payment to be made for the terminal with a communication charge included in the price of the terminal, thereby simplifying billing of the charge.

(2) A traveling machine management system according to the above (1) is provided, which is characterized in that the server comprises means which acquires resale/transfer information when the terminal is resold or transferred within the communication period and means which rewrites information accumulated in the server and/or the terminal based on the resale/transfer information.

The information rewritten in the server is primarily information on the user of the terminal. The information rewritten in the terminal is primarily information on the traveling machine on which the terminal is loaded such as the serial number and operational information of the same.

According to the invention, since changes in information resulting from resale or transfer of a traveling machine are reflected on the server, the traveling machine can be timely and properly managed.

(3) A traveling machine management system according to the above (2) is provided, which is characterized in that the terminal comprises means which inquires whether information prior to resale or transfer will be used when resale/transfer information is acquired and means which acquires necessity information on whether the information prior to the resale or transfer will be used.

The inquiry and the acquisition of the necessity information may be made by sending a message in the form of an electronic mail from the server to a system that the buyer possesses or showing an inquiry screen on a WEB site of the server when the site is accessed through the system.

According to the invention, for example, when a terminal is resold or transferred along with the traveling machine, the buyer can have operational information of the purchased traveling machine in the past as occasion demands. This allows the buyer to manage the operation of the purchased traveling machine with reference to the past information, which helps management of the maintenance of the traveling machine.

(4) A traveling machine management system according to the above (3) is provided, which is characterized in that the means acquiring the necessity information discloses the information to a user of the terminal when it acquires necessity information indicating that information prior to resale or transfer is needed and deletes the information prior to resale or transfer accumulated in the server when it acquires necessity information indicating that the information is not needed.

According to the invention, information prior to resale or transfer accumulated in the server is deleted when necessity information indicating that the information is not needed is acquired. Information on traveling machines recorded in association with terminal identifiers will not be increased than required, and burdens on the server can therefore be reduced. Thus, it is possible to load a terminal within a communication period to a different traveling machine and to use it for management of the traveling machine.

(5) A traveling machine management system according to any of the above (1) to (4) is provided, which is characterized in that the server comprises means which notifies the terminal or a system possessed by the terminal user of the fact that a predetermined period prior to the expiration of the communication period has passed.

According to the invention, since a notice can be given in advance on the expiration of the communication period of a terminal, the user of the terminal can understand how long communication can be performed with the terminal and can make an updated contract on the communication period of the terminal as occasion demands. The updated contact on the communication period is preferably made by accessing the server from the system of the user.

(6) A traveling machine management system according to any of the above (1) to (5) is provided, which is characterized in that the terminal comprises means which acquires the current position of the traveling machine carrying the terminal and in that the server comprises means which acquires current position information output by the terminal and means which outputs alarm information to a system possessed by the user of the terminal when position information acquired within the communication period is out of a preset range.

According to the invention, when a traveling machine is stolen with the terminal of the machine in a communication period, the user of the terminal or the user of the traveling machine is notified of such information, which makes it possible to prevent the traveling machine from being stolen.

### BRIEF DESCRIPTION OF THE DRAWINGS

FIG. 1 is a schematic illustration showing a configuration of a traveling machine management system according to an embodiment of the invention;

FIG. 2 is a schematic diagram showing a configuration of the traveling machine and a terminal of the embodiment;

FIG. 3 is a schematic diagram showing a configuration of a server of the embodiment;

FIG. 4 is a schematic diagram showing a configuration of a traveling machine management database of the embodiment;

FIG. 5 is a flow chart showing operations of the system of the embodiment;

FIG. 6 is another flow chart showing operations of the system of the embodiment;

FIG. 7 is another flow chart showing operations of the system of the embodiment; and

FIG. 8 is another flow chart showing operations of the system of the embodiment.

### DESCRIPTION OF PREFERRED EMBODIMENT

An embodiment of the invention will now be described with reference to the drawings.

[System Configuration]

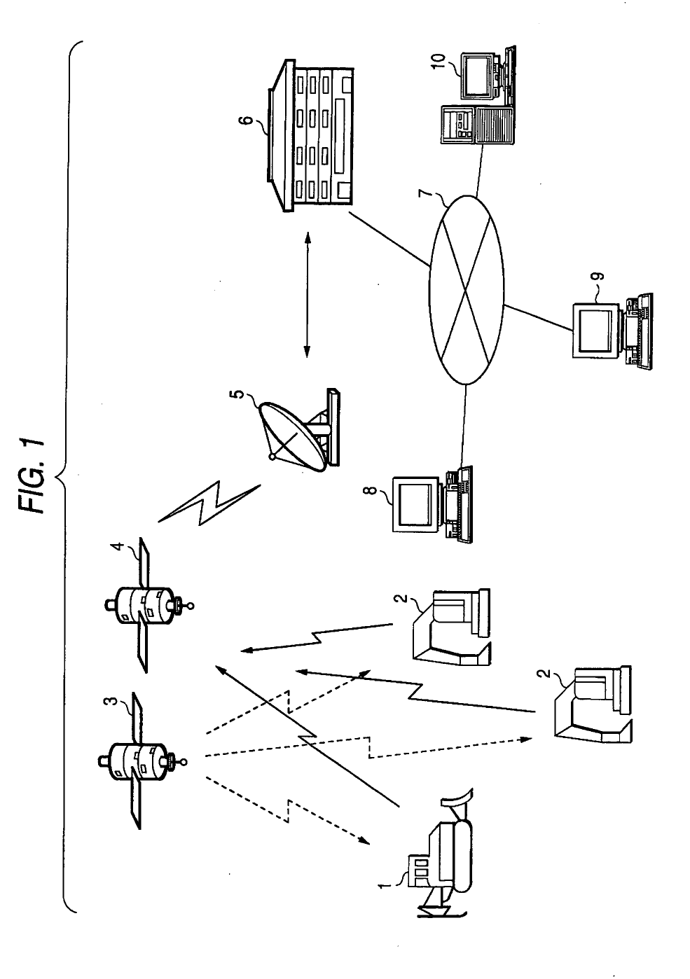

FIG. 1 is a schematic illustration showing a configuration of a traveling machine management system according to an embodiment of the invention. The management system comprises construction machines 1 and 2 as a plurality of traveling machines, GPS (global positioning system) satellites 3, a communication satellite 4, a satellite earth station 5, a network control station 6, a network 7, a user's system 8, a selling agent's system 9, and a server 10. In the system, information on the current positions and operations of the construction machines 1 and 2 output by the construction machines 1 and 2 is acquired by the server 10, and the server 10 managing the construction machines 1 and 2 manages those pieces of information and supplies them to the user's system 8 and the selling agent's system 9 as occasions demand.

The construction machines 1 and 2 are machines that perform operations such as excavation and grading at a site under construction of a building, road, or the like. A bulldozer 1 and a power shovel 2 fall under the category.

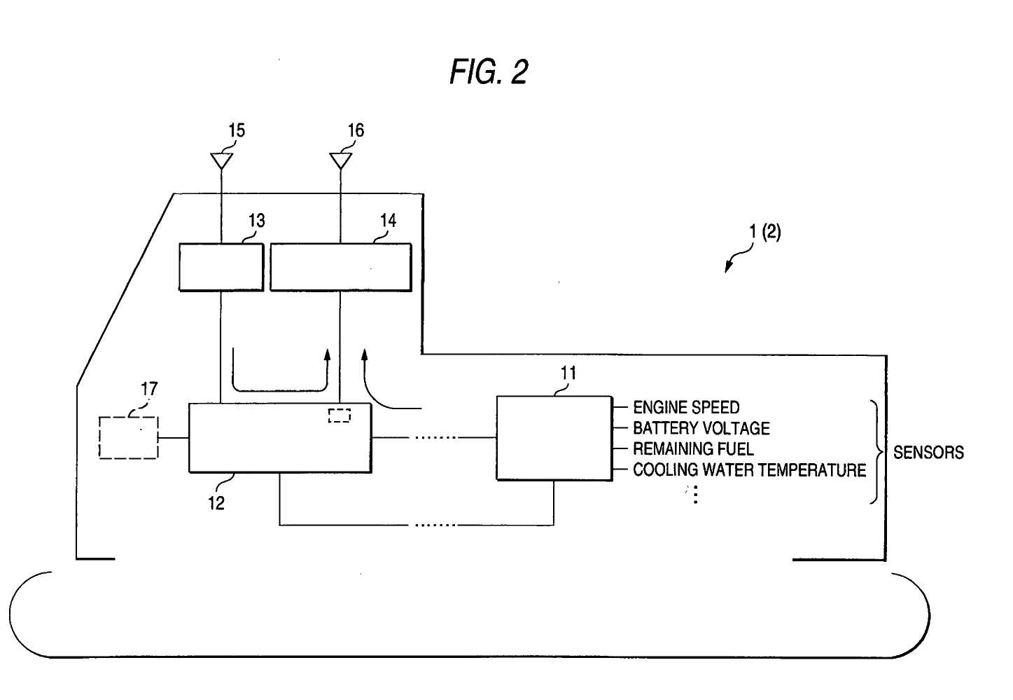

As shown in FIG. 2, the construction machines 1 and 2 have an electronic controller 11 for electrically controlling driven parts, a communication controller 12 connected to the electronic controller 11, a GPS sensor 13 and a communication terminal 14 connected to the communication controller 12, a GPS antenna 15 connected to the GPS sensor 13, and a satellite communication antenna 16 connected to the communication terminal 14.

The electronic controllers 11 receive signals from sensors which detect states of elements for driving the respective construction machines 1 and 2 such as engine speeds, battery voltages, amounts of remaining fuel, cooling water temperatures, service meters, and operating times and electronically control those elements.

The communication controllers 12 are sections for acquiring mechanical information on the respective construction machines 1 and 2 from the states the driven parts of the construction machines 1 and 2 detected by the electronic controllers 11. Specifically, the controllers 12 can acquire the amounts of remaining fuel and operational information of the respective construction machines 1 and 2. The communication controllers 12 have a storage area therein, and information such as the owner of the construction machines 1 and 2, the serial numbers of the machines themselves, and total operating hours is stored in the storage areas. Those pieces of information may alternatively be stored at the server 10.

The GPS sensors 13 are sections which receive electric waves output by a plurality of GPS satellites 3 through the GPS antenna 15 and measures the current positions of themselves based on the states of the received electric waves. Information on the current positions of the construction machines 1 and 2 acquired by the GPS sensors 13 is output to the communication controllers 12. The current position information acquired by the GPS sensors 13 may be combined with a map database which is not shown to be displayed in the form of a map on an image display 17 of a navigation system.

The current position information and operational information of the construction machines 1 and 2 acquired by the communication controllers 12 is output from the satellite communication antennas 16 through the communication terminals 14. Those pieces of information are output to the server 10 via the communication satellite 4, the satellite earth station 5, the network control station 6, and the network 7.

The communication controllers 12 and the communication terminals 14 constitute “terminals” in the context of the invention, and unique and fixed identification numbers are given to each of the terminals independently of the construction machines 1 and 2.

The communication satellite 4, the satellite earth station 5, and the network control station 6 are sections for receiving the information output by the terminals 12 and 14 and automatically transferring it to the server 10. A user who has used a satellite communication channel including the communication satellite 4, the satellite earth station 5, and the network control station 6 must pay a charge to the communication company whose possesses them. In the present embodiment, a method of payment is employed in which a terminal is sold to a user at a price including a certain communication charge added thereon to allow the user to use such satellite communication for a predetermined period after the sale at that price.

The network 7 is configured as an internet based on a general-purpose protocol such as TCP/IP. In addition to the network control station 6 and the server 10, the user's system 8 that is installed in a management office at the construction site and the selling agent's system 9 for sale and maintenance of the construction machines 1 and 2 are connected to the network 7. The user's system 8 and the selling agent's system 9 are general-purpose computers each including a computer main body having a processing unit and a storage unit, input devices such as a keyboard and a mouse connected to the computer main body, and a display. A browser program for accessing home pages on the internet and an electronic mail program are installed in the systems to allow them to communicate with the server 10.

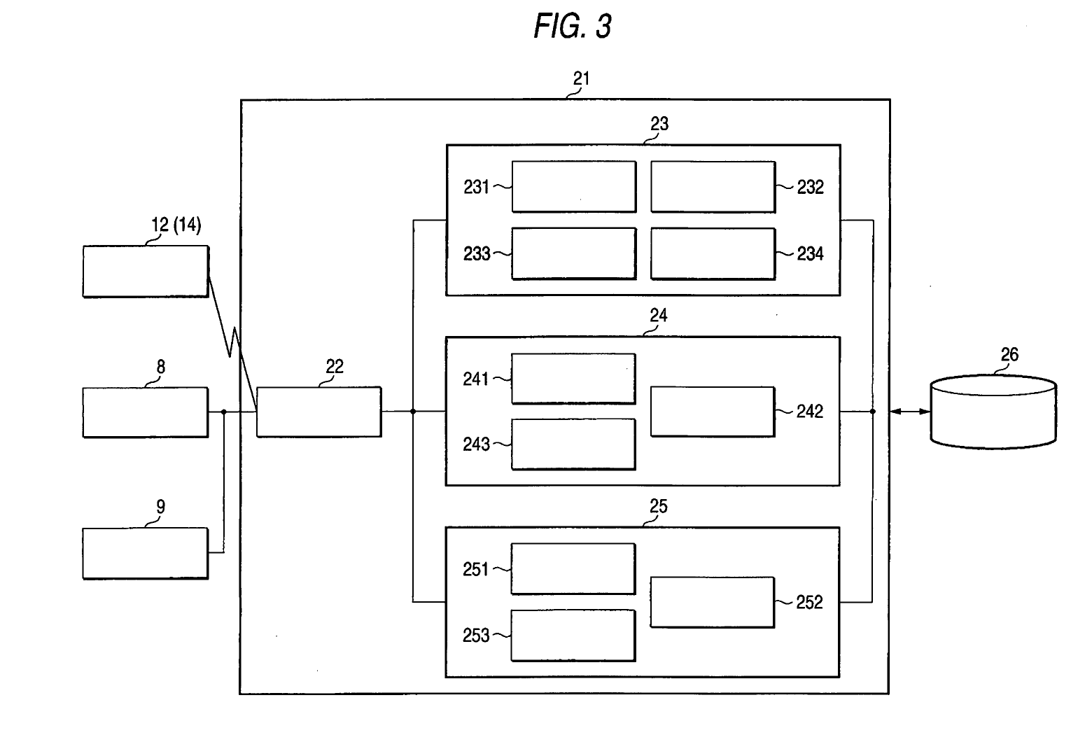

The server 10 is configured as a WWW (world wide web) server connected to the network 7, and it has a processing unit 21 for executing various programs and a storage unit such as a hard disk for storing information transmitted and received, as shown in FIG. 3.

The processing unit 21 comprises an input/output control section 22 for controlling input and output of data to and from the processing unit 21 and a data acquisition/update section 23, a data reading/referring section 24, and a data generation/output section 25 as programs to be developed on a database management system running on the processing unit 21.

A traveling machine management database 26 for managing the travels of the traveling machines 1 and 2 is built in the storage unit.

The input/output control section 22 is a section for controlling information input and output through the network 7. Specifically, it performs input/output control of information input from the terminals 12 and 14 through the satellite communication channel and information exchanged between the user's system 8 and the selling agent's system 9 through the network 7.

The data acquisition/update section 23 is a section for acquiring information input from the terminals 12 and 14 and the selling agent's system 9 and for updating the database as occasions demand. The section 23 has an identifier acquisition portion 231, a transfer information acquisition portion 232, a necessity information acquisition portion 233, and a terminal position information acquisition portion 234.

The identifier acquisition portion 231 is a portion for acquiring fixed terminal identification codes given to the terminals 12 and 14. Communication between the server 10 and the terminals 12 and 14 is performed by identifying the terminals 12 and 14 from the terminal identification codes regardless of the types of the construction machines 1 and 2 on which the terminals 12 and 14 are loaded, and information in the traveling machine management database 26 is rewritten as occasions demand.

The transfer information acquisition portion 232 is a portion for acquiring information on a new owner of the construction machines 1 and 2 when the construction machines 1 and 2 are resold or transferred. Since they are resold or transferred with the intervention of the selling agent in most cases, the transfer information acquisition portion 232 normally acquires transfer information output by the selling agent's system 9. A rental agent who owns a multiplicity of the construction machines 1 and 2 and who rents them to a constructor may be treated the same as a selling agent when they resell the construction machines 1 and 2 in their possession to another constructor.

The necessity information acquisition portion 233 is a portion for inquiring a new owner of the construction machines 1 and 2 when they are resold or transferred whether the owner requires information such as operational history of the construction machines 1 and 2 which has been acquired and accumulated from the terminals 12 and 14 and for acquiring necessity information from the new owner in response to the inquiry. Referring to the acquisition of the information specifically, the necessity information acquisition portion 233 inquires a user's system 8 possessed by the new owner through the network 7 whether the information will be used or not and acquires necessity information from a reply sent through an operation on the user's system 8.

The terminal position information acquisition portion 234 is a portion for acquiring information on the current positions of the terminals 12 and 14 which has been acquired by the GPS sensors 13 of the construction machines 1 and 2 and output by the terminals 12 and 14. It updates information on the current positions of the construction machines 1 and 2 to be managed accumulated in the traveling machine management database 26 based on the current position information thus acquired.

The data reading/referring section 24 is a section for searching the traveling machine management database 26 for information that matches predetermined conditions presented by the user of the terminals 12 and 14 through an operation on the user's system 8 and for extracting the information to output it as a reply to the user's system 8. The section 24 has a condition acquisition portion 241, an information searching portion 242, and a reply/result outputting portion 243.

The condition acquisition portion 241 presents a predetermined menu screen associated with information search to the user's system 8 which has accessed the server 10. The user's system 8 specifies the construction machine 1 or 2 as an object of search and selects information to be obtained based on the menu and provides an output to the condition acquisition portion 241 accordingly. When the condition acquisition portion 241 acquires the search conditions from the user's system 8, it outputs the conditions to the information searching portion 242.

The information searching portion 242 searches information in the traveling machine management database 26 based on the acquired search conditions to perform extraction according to the applicable conditions.

A result of extraction is output to the reply/result output portion 243, and the reply/result output portion 243 forms the extraction result into a predetermined format and outputs it to the user's system 8 as a reply or result.

The data generation/output section 25 is a section for continually or periodically monitoring the information accumulated in the traveling machine management database 26, generating data of a message associated with a significant update or change of the information if any, and transmitting the generated data to the terminals 12 and 14, the user's system 8, and the selling agent's system 9. The section 25 has a communication expiry notification portion 251, a state change monitoring portion 252, and an alarm information output portion 253.

The communication expiry notification portion 251 is a portion for generating a message indicating that the period of communication using the satellite communication channel allowed for the terminals 1 and 2 is nearly expired and for transmitting the same to the user's system 8.

The state change monitoring portion 252 is a portion for monitoring the information accumulated in the traveling machine management database 26. When there is a change in the accumulated information, it outputs the change to the communication expiry notification portion 251 and the alarm information output portion 253.

When the state change monitoring portion 252 recognizes any abnormality in the current position information of the construction machines 1 and 2 that is updated by the terminal position information acquisition portion 234, the alarm information output portion 253 generates information indicating a possibility of a theft and transmits the information to the user's system 8. When information on the occurrence of a failure in the construction machine 1 or 2 is input from the terminal 12 or 14 and the state of the traveling machine management database 26 changes accordingly, the alarm information output portion 253 generates alarm information associated with the failure and transmits the alarm information to the user's system 8 and the selling agent's system 9.

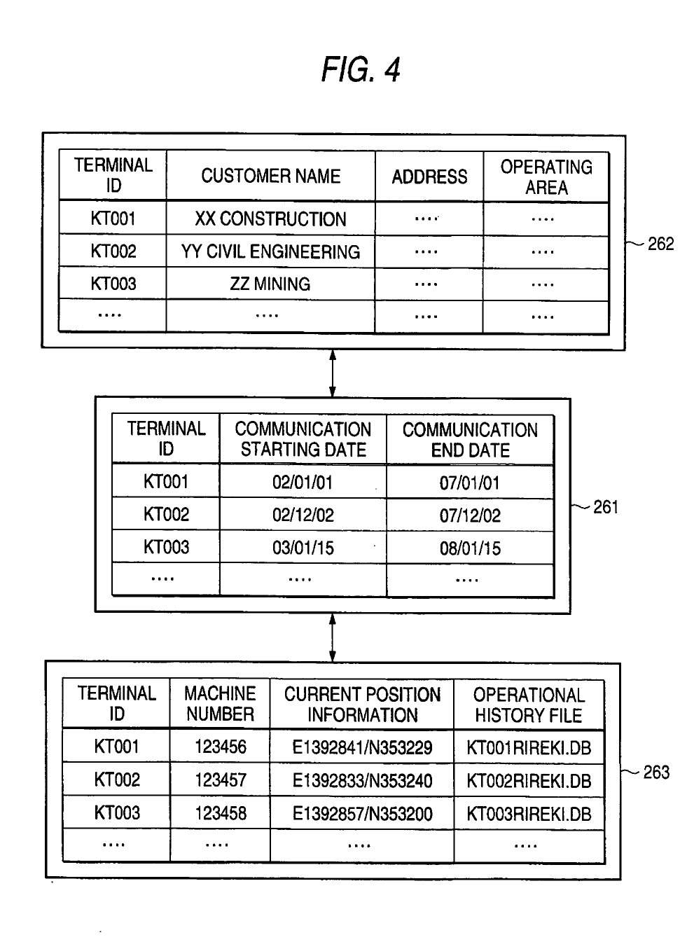

Referring to the structure of the traveling machine management database 26, as shown in FIG. 4, it is configured as a relational database including a plurality of tables such as a terminal identification code management table 261, a terminal user management table 262, and a machine information table 263.

The terminal identification code management table 261 is configured as a table in which the identification code (shown as “terminal ID” in FIG. 4), communication starting date, and communication ending date of each of the terminals 12 and 14 under management constitute one record.

The terminal user management table 262 is a table for managing information on users of the terminals 12 and 14. The specific name (customer name), address, and operating area of the user and other information such as a mail address of the user's system 8 are accumulated for each of the terminal identification codes for the terminals 12 and 14.

The machine information table 263 is a table for managing loading of the terminals 12 and 14 on the construction machines 1 and 2. In association with each of the terminal identification codes of the terminals 12 and 14, the number of the machine on which the terminal is loaded and the current position information and operational history of the same are accumulated. In the present embodiment, since operational history is configured as a separate database, a link to an operational history file is pasted in each record in accordance with the terminal identification code. When a reference is to be made to the operational history of the construction machine 1 or 2 according to the terminal identification code, the required information can be acquired by referring to the operational history file according to the terminal identification code.

[System Operation]

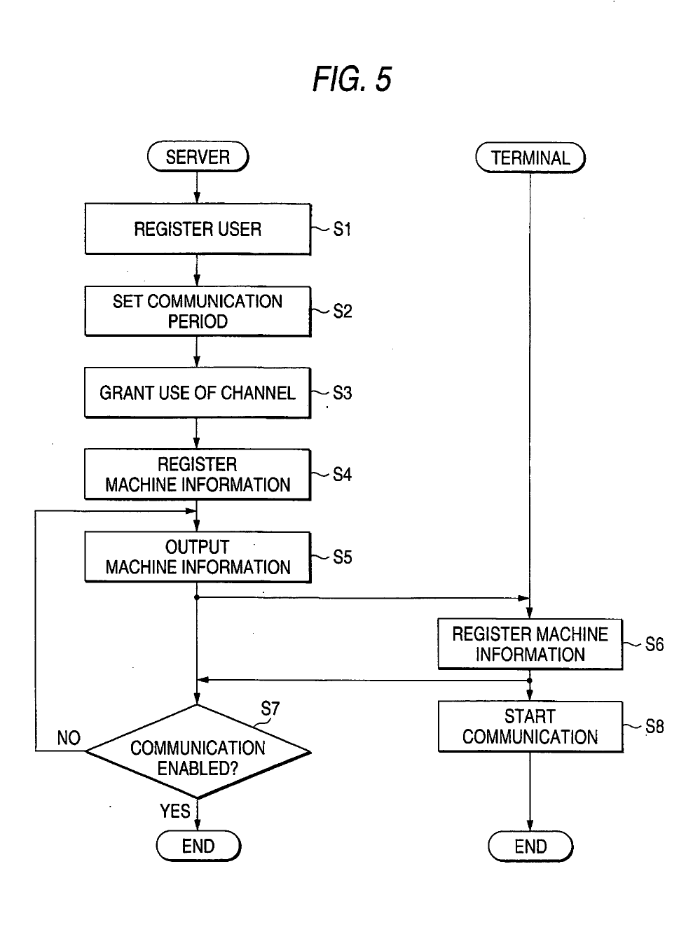

Operations of the above-described managing system will now be described with reference to FIGS. 5 to 8.

(1) Registration of a New Terminal

When new terminals 12 and 14 are to be registered, the registration is carried out according to the flow chart shown in FIG. 5.

(1-1) When the construction machines 1 and 2 loaded with the terminals 12 and 14 are sold to a user at a selling agent, information on the user who bought the machines is registered at and output by the selling agent's system 9. The user information is accepted by the data acquisition/update section 23 of the server 10. The data acquisition/update section 23 performs data update and registration in the terminal user management table 262 of the traveling machine management database 26 using the terminal identification codes of the terminals 12 and 14 included in the user information as key codes (step S1). When the terminals 12 and 14 are loaded on the construction machines 1 and 2 when they are purchased at the selling agent, a maintenance contract and a special agreement associated with a burglary insurance contract may be added for the terminals 1 and 2 to reduce the total cost.

(1-2) The identifier acquisition portion 231 acquires the terminal identification codes included in the user information and sets a starting date and an ending date of a communication period to the terminal identification codes to set a communication period for each of the terminal identification code (step S2).

(1-3) When setting of the communication periods of the terminals 12 and 14 is completed, a declaration is made to grant the use of the communication network by the terminal identification codes associated with registration (step S3) to register machine information of the construction machines 1 and 2 on which the terminals 12 and 14 are loaded (step S4).

(1-4) When the registration of the machine information is completed, the data generation/output portion 25 outputs the registered machine information to the terminals 12 and 14 through the communication network (step S5). Upon receipt of the machine information, the terminals 12 and 14 register the machine information in the storage units of themselves (step S6). In the present embodiment, the registration of the machine information in the terminals 12 and 14 is entirely performed based on information from the server 10 on the assumption that remote operation is performed. Alternatively, the machine information to be registered by the server 10 may be registered in advance in the terminals 12 and 14.

(1-5) When the registration of the machine information is completed, the terminals 12 and 14 output information confirming completion of the registration to the server 10. The identifier acquisition portion 231 of the server 10 checks the confirmation information thus output to see whether the terminal identification codes of the terminals 12 and 14 are properly given to ensure proper communication (step S7) and terminates the process if there is no problem. Thus, the terminals 12 and 14 start communication (step S8).

(2) Communication between Terminals and Server

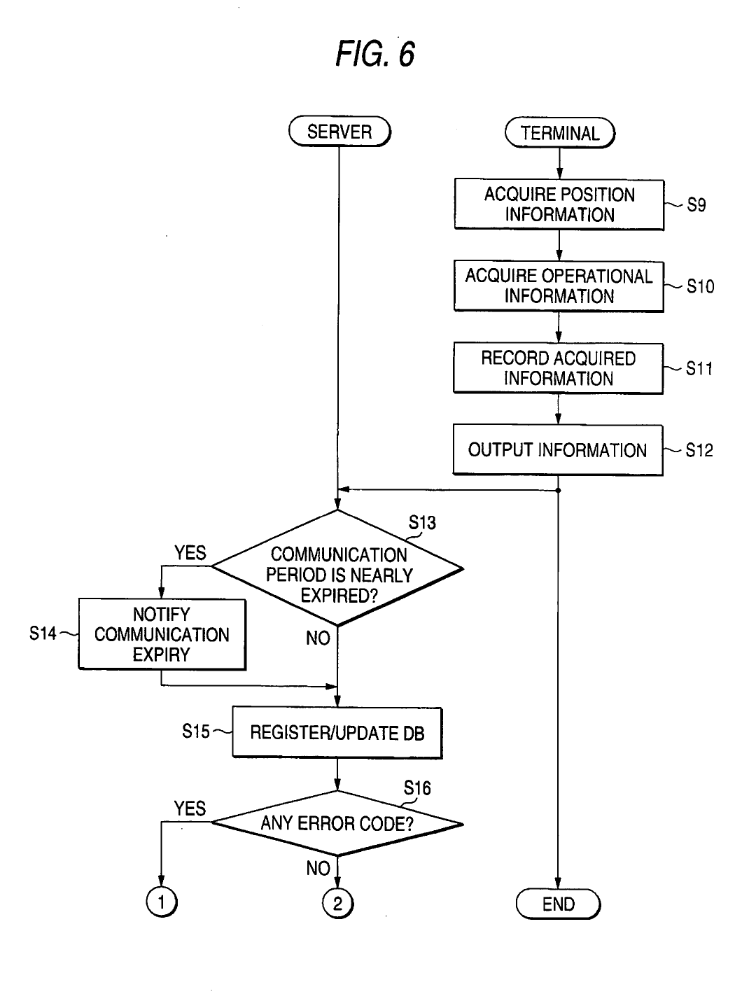

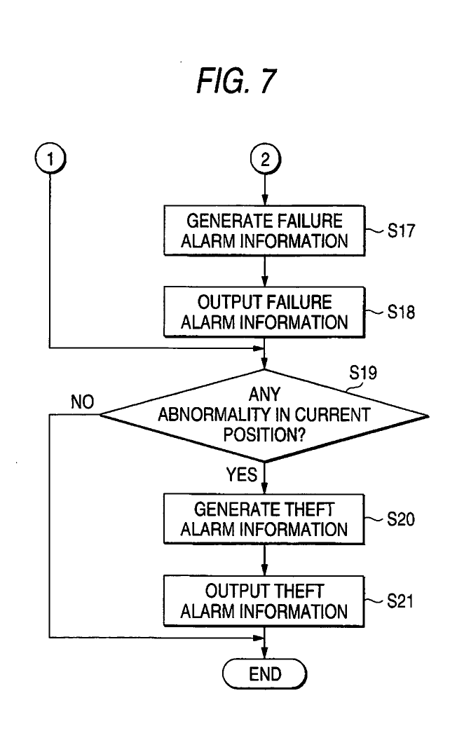

A method for recording the operational information of the construction machines 1 and 2 carrying the registered terminals 1 and 2 in the traveling machine management database 26 of the server 10 is carried out according to the flow charts shown in FIGS. 6 and 7.

(2-1) The terminals 12 and 14 periodically acquire the current position information of the construction machines 1 and 2 from the GPS sensors 13 (step S9) and simultaneously acquire operational information of the construction machines 1 and 2 in operation from the electronic controllers 11 (step S10).

(2-2) The pieces of information thus acquired are recorded in the storage units in the terminals 12 and 14 (step S11) and are thereafter transmitted to the server 10 through the satellite communication network and the network 7 (step S12).

(2-3) The identifier acquisition portion 231 of the server 10 acquires the terminal identification codes from the information transmitted and refers to the terminal identification code management table 261 in the traveling machine management database 26 to judge whether the transmitted communication periods of the terminals 12 and 14 are near the expiry or not (step S13).

(2-4) When the communication periods are near the expiry, the communication expiry notification portion 251 creates a message indicating that expiry is near and transmits the message to the terminals 12 and 14 and the user's system 8 (step S14).

(2-5) The transmitted information is accepted by the terminal position information acquisition portion 234, and the terminal position information acquisition portion 234 acquires the current position information of the construction machines 1 and 2 from the information, updates or registers the current position information in the machine information table 263 in the traveling machine management database 26, and also updates or registers data in the operational history files registered in the same records (step S15).

(2-6) While the information in the traveling machine management database 26 is being updated as thus described, the state change monitoring portion 252 monitors the contents being updated to judge whether any error code is included in the information accumulated in the operational history files (step S16). If there is no error code, the process directly proceeds to the next step.

(2-7) When an error code is found by the state change monitoring portion 252, the state change monitoring portion 252 specifies the part of the construction machine 1 or 2 from which the error code originates and acquires the degree of importance of the part having an error and measures to take as occasion demands. Based on such information, the alarm information output portion 253 generates failure alarm information including information on the failed part and the measures to take (step S17) and outputs the failure alarm information to the user's system 8 and the selling agent's system 9 through the network 7 (step S18).

(2-8) Next, the state change monitoring portion 252 judges whether the construction machines 1 and 2 are greatly apart from the operating area of the user from the acquired current position information of the construction machines 1 and 2 (step S19). When they are not significantly apart from the operating area, the process is terminated based on a judgment that there is no abnormality.

(2-9) When the state change monitoring portion 252 judges that there is abnormality in the current positions, the alarm information output portion 253 generates theft alarm information (step S20). Referring to the theft alarm information, it is preferable to provide information representing the current positions of the construction machines 1 and 2 by generating image information that is a combination of the current position information and map information in addition to a message indicating a possibility of a theft. The theft alarm information thus generated is output to the user's system 8 through the network 7 (step S21).

(3) Processes at Resale or Transfer of Construction Machines

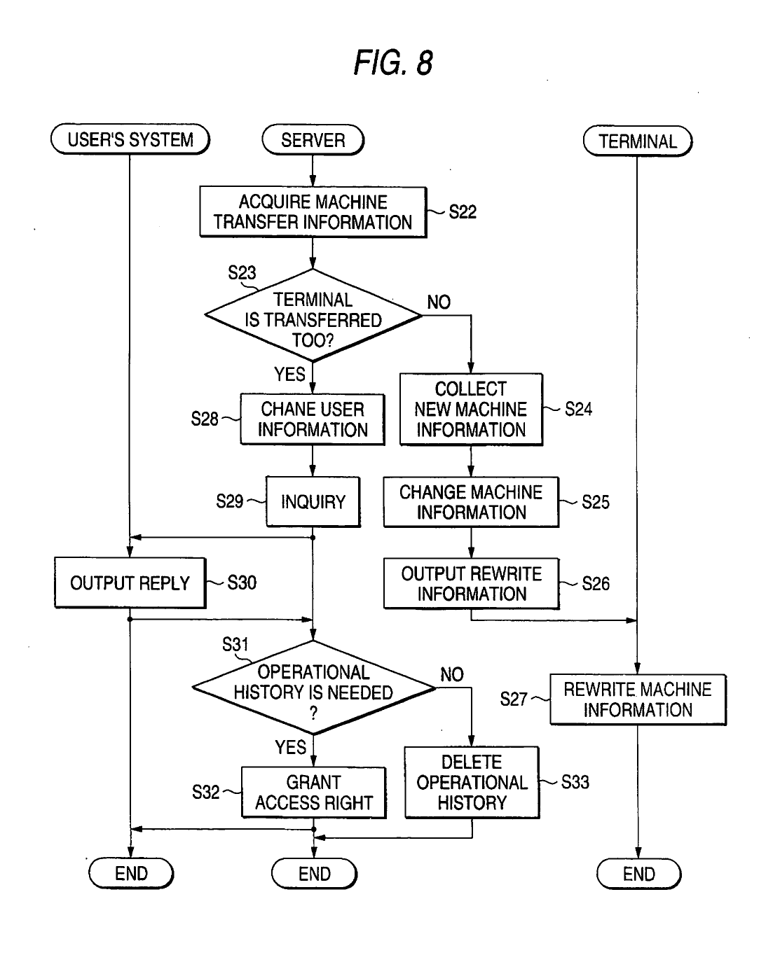

When the user name of the construction machine 1 and 2 is changed as a result of resale or the like, information processing associated with resale or transfer is performed according to the flow chart shown in FIG. 8.

(3-1) When the construction machines 1 and 2 are resold by a selling agent as used construction machines, the selling agent resisters information on the resale using the selling agent's system 9 and outputs it to the server 10. The transfer information acquisition portion 232 of the server 10 acquires the information on the transfer of the construction machines 1 and 2 from the selling agents' system 9 (step S22). The transfer information acquisition portion 232 judges from the transfer information whether the construction machines 1 and 2 have been transferred along with the terminals 12 and 14 or the construction machines 1 and 2 have been transferred separately from the terminals 12 and 14 (step S23).

(3-2) When the construction machines 1 and 2 have been transferred separately from the terminals 12 and 14, since the user of the terminals 12 and 14 has not changed, the information in the terminal user management table 262 is not rewritten. The transfer information acquisition portion 232 acquires information on other construction machines 1 and 2 possessed by the user on which the terminals 12 and 14 will be loaded (step S24). Since the terminals 12 and 14 are normally loaded on machines at the factory of the selling agent, the information can be acquired from the selling agent's system 9.

(3-3) When the new construction machines 1 and 2 to carry the terminals 12 and 14 are identified, machine information associated with the construction machines is overwritten to be changed to the information of the terminal identification codes associated with terminals 12 and 14 (step S25). When the updating of data in the traveling machine management database 26 is completed, the server 10 transmits the contents of the change to the terminals 12 and 14 as rewrite information through the satellite communication channel (step S26), and the terminals 12 and 14 rewrite the machine information in the respective storage units into the machine information of the new construction machines 1 and 2 carrying the terminals based on the rewrite information (step S27), which terminates the process.

(3-4) When the terminals 12 and 14 are transferred along with the construction machines 1 and 2 that are resold, the transfer information acquisition portion 232 changes information on the buyer of the construction machines 1 and 2 to information in the users of the terminals 12 and 14 and updates the records in the terminal user management table 262 according to the terminal identification codes (step S28).

(3-5) When the updating of the records in the terminal user management table 262 is completed, the necessity information acquisition portion 233 inquires the user's system 8 whether the operational history of the construction machines 1 and 2 in the past accumulated in the terminals 12 and 14 and the traveling machine management database 26 will be used or not (step S29). The inquiry may be made by prompting access to the site of the server 10 or asking whether the history will be used or not by an electric mail.

(3-6) When the user of the terminals 12 and 14 operates the user's system 8 to output a reply to the inquiry from the user's system 8 (step S30), the necessity information acquisition portion 233 judges whether the new user needs the past operational history based on information on the replay thus output (step S31).

(3-7) In the case of a reply indicating a need for the operational history, the necessity information acquisition portion 233 grants the user's system 8 a right to access the traveling machine management database 26 (step S32) to disclose information recording the operational history of the construction machines 1 and 2 in the past.

(3-8) In the case of a reply indicating no need for the operational history, the necessity information acquisition portion 233 deletes the information regarding the operational history from the traveling machine management database 26 (step S33) and generates new operational history files to accumulate operational history thereafter.

The above-described embodiment has the following advantages.

Unique and fixed terminal identification codes are given to the terminals 12 and 14, and the construction machines 1 and 2 are managed at the server 10 based on the terminal identification codes to allow the construction machines 1 and 2 to be managed on the basis of the terminals 12 and 14. Therefore, the management can be carried out independently of the transfer of the construction machines 1 and 2 without relying upon the traveling machines 1 and 2 on which the terminals are loaded.

The terminal identification code management table 261 is set in the traveling machine management database 26, and a link is provided between the table and the machine information table 263. Since this allows operational information and position information of the construction machines 1 and 2 to be managed as done in the related art, a state of management similar to that in the related art can be maintained.

By managing the communication periods of the terminals 12 and 14 based on the terminal identification codes of the terminals, the terminals 12 and 14 can be traded with a predetermined communication period set available for the terminals in advance. This allows a prepayment or lump sum payment to be made for the terminals 12 and 14 with communication charges included in the prices of the terminals, thereby simplifying billing of the charges.

Since the server 10 updates resale and transfer information of the construction machines 1 and 2 each time they are resold or transferred, the construction machines 1 and 2 can be timely and properly managed utilizing the terminals 12 and 14.

An inquiry is made to see the necessity of the operational history of the construction machines 1 and 2 which have been resold, and operational history information is disclosed according to necessity information that is a reply to the inquiry. Thus, the buyer can manage the maintenance of the construction machines 1 and 2 with reference to the operational history of the same, which also makes it possible to extend the life of the construction machines 1 and 2.

Because of the configuration in which the operational history recorded in the server 10 prior to the resale or transfer is deleted in the case of necessity information indicating that the operational history is not needed, burdens on the server 10 can be reduced.

When the communication period is nearly expired, the communication expiry notification portion 251 transmits information indicating the same to the user's system 8. This allows the user to extend or update the communication period of the terminals 12 and 14 as occasion demands, which makes it possible to prevent situations in which the management system is disabled as the communication period expires.

In case that the construction machine 1 or 2 fails or is stolen, the alarm information output portion 253 outputs alarm information to the user's system 8 or selling agent's system 9. This makes it easy to prevent a theft and to rationalize maintenance. In particular, special agreements may be added in a burglary insurance contract and a maintenance contract associated with the purchase of the terminals 12 and 14 as a result of such rationalization, which makes it possible to achieve a reduction in the total cost.

The invention is not limited to the above-described embodiment, and modifications as described below are included in the scope of the same.

Although the invention is used as a system for managing the construction machines 1 and 2 in the above-described embodiment, this is not limiting the invention. In short, the invention may be used for any machine that travels, and the invention may be used for vehicle such as cabs.

Although information is exchanged between the terminals 12 and 14 and the server 10 through the dedicated satellite communication channel utilizing the communication satellite 4 in the above-described embodiment, this is not limiting the invention. Specifically, information may be exchanged through a public radio network such as a mobile phone and PHS.

Specific structures and procedures for carrying out the invention may be modified within a scope in which the object of the invention is still achieved.

What is claimed is:

1. A traveling machine management system comprising:
a terminal provided on a traveling machine; and
a server connected to the terminal through a communication channel for managing the traveling machine, wherein a unique and fixed identifier is given to the terminal and wherein the server has means which acquires the identifier of the terminal and means which manages a communication period of the terminal based on the acquired identifier.

2. The traveling machine management system according to claim 1, wherein the server further has means which acquires resale/transfer information on the terminal when the terminal is resold or transferred within the communication period and means which rewrites information on the terminal accumulated in the server and/or the terminal based on the resale/transfer information.

3. The traveling machine management system according to claim 2, wherein the server even further has means which inquires whether information prior to the resale or transfer will be used when the resale/transfer information is acquired and means which acquires necessity information on whether the information prior to the resale or transfer will be used.

4. The traveling machine management system according to claim 3, wherein the means acquiring the necessity information discloses the information to a user of the terminal when it acquires the necessity information indicating that information prior to the resale or transfer is needed and deletes the information prior to the resale or transfer accumulated in the server when it acquires the necessity information indicating that the information is not needed.

5. The traveling machine management system according to claim 1, wherein the server has means which notifies the terminal or a system possessed by the terminal user of the fact that a predetermined period prior to the expiration of the communication period has passed.

6. The traveling machine management system according to claim 1, wherein:
the terminal has means which acquires current position of the traveling machine carrying the terminal and
the server has means which acquires the current position information output by the terminal and means which outputs alarm information to the system possessed by the user of the terminal when the position information acquired within the communication period is out of a preset range.

7. The traveling machine management system according to claim 5, wherein:
the terminal has means which acquires current position of the traveling machine carrying the terminal and
the server has means which acquires the current position information output by the terminal and means which outputs alarm information to the system possessed by the user of the terminal when the position information acquired within the communication period is out of a preset range.

8. The traveling machine management system according to claim 2, wherein the server has means which notifies the terminal or a system possessed by the terminal user of the fact that a predetermined period prior to the expiration of the communication period has passed.

9. The traveling machine management system according to claim 2, wherein:
the terminal has means which acquires current position of the traveling machine carrying the terminal and
the server has means which acquires the current position information output by the terminal and means which outputs alarm information to the system possessed by the user of the terminal when the position information acquired within the communication period is out of a preset range.

10. The traveling machine management system according to claim 3, wherein the server has means which notifies the terminal or a system possessed by the terminal user of the fact that a predetermined period prior to the expiration of the communication period has passed.

11. The traveling machine management system according to claim 3, wherein:
the terminal has means which acquires current position of the traveling machine carrying the terminal and
the server has means which acquires the current position information output by the terminal and means which outputs alarm information to the system possessed by the user of the terminal when the position information acquired within the communication period is out of a preset range.

12. The traveling machine management system according to claim 4, wherein the server has means which notifies the terminal or a system possessed by the terminal user of the fact that a predetermined period prior to the expiration of the communication period has passed.

13. The traveling machine management system according to any of claim 4, wherein:
the terminal has means which acquires current position of the traveling machine carrying the terminal and
the server has means which acquires the current position information output by the terminal and means which outputs alarm information to the system possessed by the user of the terminal when the position information acquired within the communication period is out of a preset range.
